(19) United States
(12) Patent Application Publication
(10) Pub. No.: US 2015/0324803 A1
(43) Pub. Date: Nov. 12, 2015

(54) DEVICE-BASED TRANSACTION CONFIRMATION

(71) Applicant: TollShare, Inc., Danville, CA (US)

(72) Inventors: Murali M. Karamchedu, Portland, OR (US); Ravi Asnani, Los Angeles, CA (US)

(73) Assignee: TollShare, Inc., Danville, CA (US)

(21) Appl. No.: 14/273,463

(22) Filed: May 8, 2014

(51) Int. Cl. G06Q 20/42

(52) U.S. Cl. CPC G06Q 20/425

(57) ABSTRACT

In various embodiments, facilitation of transactions is described. A customer may provide identifying information, such as a communication address, to a provider of goods and/or services. The provider, may, in turn, send a request to a device-based transaction facilitation system (“TFS”) to determine whether the identified customer wishes to participate in the requested transaction. The TFS may send a message to a device of the customer, such as a mobile phone of the customer. The customer may be facilitated in sending back a confirmation that the customer wishes to participate in the transaction. This confirmation may include a unique identifier of the device under control of the customer. The TFS, on receipt of the unique identifier, may then send a confirmation that the customer wishes to participate, and the provider, in turn, may complete the transaction with the customer. Other embodiments may be described and claimed.

### TECHNICAL FIELD

The present disclosure relates to the field of data processing, in particular, to apparatuses, methods and storage media associated with performing transactions.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Individual parties engage in multiple commercial and legal transactions every day. Many of these transactions are reliant on individual-specific information, such as financial information, logins, passwords, and/or other unique or identifying information. However, transmission of such information may be difficult or insecure. For example, passwords that are required for secure logins may be sniffed or obtained through key logging. In another example, credit card information may be obtained during a purchase transaction if insecure methods are used to transmit the credit card information. Further, because of the myriad pieces of information that may be associated with an individual, the individual may find themselves remembering and/or looking up many disparate logins/numbers/etc. This can lead to errors and or insecure means to store all of these pieces of information.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for transaction facilitation, in accordance with various embodiments.

FIG. 2 illustrates an example process for facilitating transactions, in accordance with various embodiments.

FIG. 3 illustrates an example process for confirming participation in a transaction, in accordance with various embodiments.

FIG. 4 illustrates an example use case of facilitating a login transaction, in accordance with various embodiments.

FIG. 5 illustrates an example use case of facilitating a purchase transaction, in accordance with various embodiments.

FIG. 6 illustrates an example use case of facilitating a time-based transaction, in accordance with various embodiments.

FIG. 7 illustrates an example computing environment suitable for practicing various aspects of the present disclosure, in accordance with various embodiments.

FIG. 8 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

In various embodiments, methods, systems, apparatuses, devices, and computer-readable media directed to facilitation of transactions are described. In various embodiments, a customer may provide identifying information to a provider of goods and/or services, such as, for example, a web-site, a merchant, or a service provider. In various embodiments, the identifying information may include a communication address for a mobile phone under control of the customer, e.g., a phone number or an IP address. The provider, may, in turn, send a request to determine whether the identified customer does indeed wish to participate in the requested transaction.

In various embodiments, the provider may send the request to a device-based transaction facilitation system (“TFS”), which may be configured to confirm that the customer identified by the communication address wishes to participate in the transaction. In various embodiments, the TFS may send a message to the device under control of the customer, such as, for example, by sending a Short Message Service (“SMS”) message in the embodiments of a mobile phone with the phone number being provided. In various embodiments, the customer may be facilitated in sending back a confirmation that the customer wishes to participate in the transaction. In various embodiments, this confirmation may include a unique identifier of the device under control of the customer, such as, in the example of a mobile phone, an International Mobile Station Equipment Identity (“IMEI”) number for the device, which is unique among all devices. The TFS, on receipt of the correct IMEI, may then send a confirmation that the customer wishes to participate in the transaction, and the provider, in turn, may complete the transaction with the customer. In some embodiments, prior to sending the confirmation, the TFS may compare this IMEI number to a stored IMEI number to confirm an identity for the customer, and may send the confirmation if the customer matches an identity in the request received from the provider. In other embodiments, other unique identifiers, such as a phone number for a mobile phone, may be used.

In various embodiments, the TFS may facilitate a transaction by allowing completion of a transaction based on a relatively small amount of transmitted information such as, for example, a phone number or an IP address. Because a transaction may be completed without requiring additional information to be transmitted, the TFS may provide for a more secure and easy-to-use system for transactions than in traditional transaction techniques.

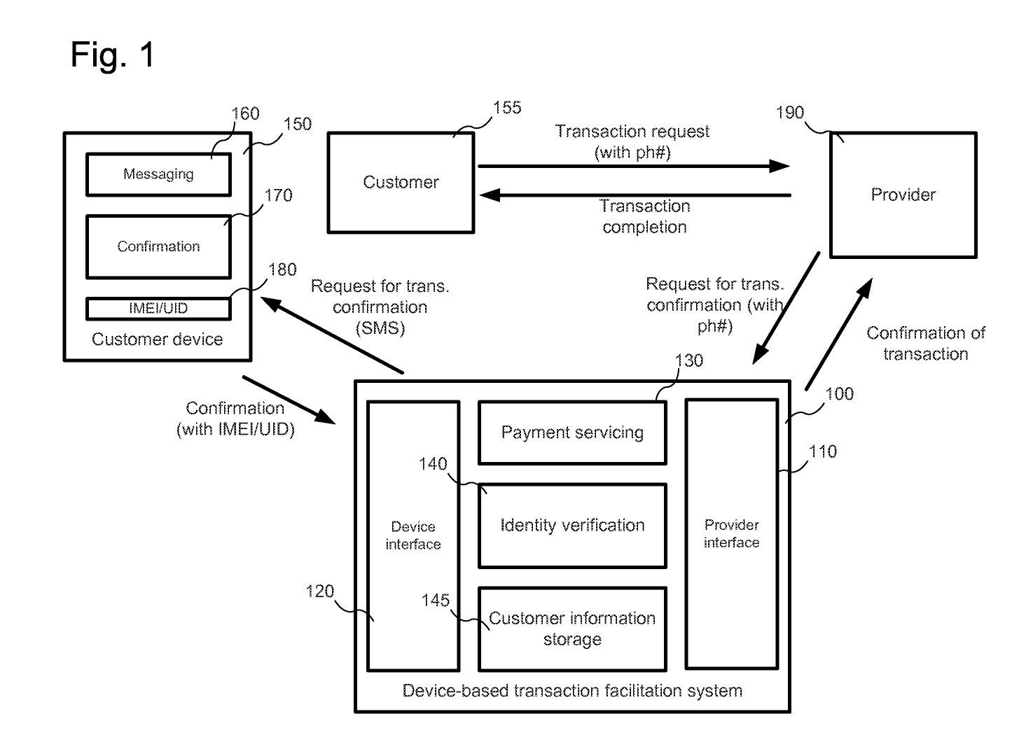

Referring now to FIG. 1, an example arrangement for facilitation of transaction is shown. In various embodiments, a device-based transaction facilitation system 100 (“TFS 100”) may be configured to interact with a customer device 150 and a provider 190 in order to facilitate a transaction between the provider 190 and a customer 155 that has control of the customer device 150. In various embodiments, the provider 190 may include various providers of goods and/or services, such as, but not limited to, online services, financial services, sales of goods; sales of tickets to events, and other services and goods. Particular examples of providers 190 are described below with respect to particular example use cases.

In various embodiments, the customer device 150 under control of the customer 155 may include various mobile and non-mobile computing devices. In particular example embodiments described herein, the mobile device 150 may include a mobile phone that is associated with a particular phone number. However, in alternative embodiments, other devices may be utilized, in particular devices that are associated with a particular piece of identifying information (such as a phone number, email, or other piece of information) and are configured to receive messages based on this piece of identifying information. Particular examples of these message are described below.

In various embodiments, the TFS 100 may be configured to communicate with the provider 190 and the customer device 150 to facilitate transactions. In various embodiments, the TFS 100 may include one or more modules to facilitate transactions. For example, the TFS 100 may include a provider interface module 110, which may be configured to receive and/or send messages and/or data between the TFS 100 and the provider 190. In various embodiments, the provider interface module 110 may be configured to provide human-usable interface, such as, for example, a web interface including graphics and/or text, through which a human associated with the provider may communicate with the TFS 100. In other embodiments, the provider interface 110 may include one or more automated communication protocols, such that automated communications may be performed between the provider 190 (and/or one or more computing devices under control of the provider 190) and the TFS 100.

Similarly, the TFS 100 may include a device interface module 120. In various embodiments, the device interface module 120 may be configured to communicate with one or more customer devices. In various embodiments, such communication may be performed with identifying information for the customer device, such as a phone number. Thus, in some embodiments, the device interface 120 may be configured to communicate via Short Message Service (“SMS”) with the customer device. In other embodiments, other communication protocols, such as hypertext transfer protocol (HTTP) using IP addresses, may be used.

In various embodiments, the TFS 100 may be configured to receive a request to confirm the customer's wish to participate in a transaction from the provider 190. In various embodiments, the request for transaction confirmation may be received from the provider 190 in response to a request from the customer 155 for a transaction. In various embodiments, the request sent by the provider 190 may include identifying information for the customer 155 and/or the customer device 150. For example, in various embodiments, in various embodiments, the identifying information may include a communication address that was previously provided to the provider 190 by the customer 155, such as when the customer requested a transaction with the provider 190. The provider 190 may then, in turn provide the communication address to the TFS 100 when sending a request to confirm the customer's wish to participate in the transaction. The request received from the provider 190 may also include additional information about the transaction, such as an identification of the transaction, a purchase amount, etc.

In various embodiments, the TFS 100 may configured such that, in response to receiving the request to confirm the customer's wish to participate in the transaction, the TFS 100 may send a message to the customer device 150 to request confirmation of whether the customer 155 wishes to participate in the requested transaction. In various embodiments, the TFS 100 may be configured to send a message containing text, images, video, and/or HTML or other code for viewing by the customer 155. In various embodiments, the TFS 100 may send the message via SMS or another protocol. The message sent by the TFS 100 to the customer device 150 may also include additional information about the transaction, such as that received from the request from the provider 190. Such information may include an identification of the transaction, a purchase amount, etc.

In various embodiments, the customer device 150 may be configured to include with one or more modules to receive the message send by the TFS 100 and to facilitate transactions through interactions with the customer 155. For example, the customer device 150 may include a messaging module 160. In some embodiments, the messaging module 160 may be configured to receive a message requesting confirmation that the customer wishes to participate in a transaction. In some embodiments, the messaging module 160 may be configured to accept SMS messages; in other embodiments, the messaging module 160 may be configured to accept messages via other protocols. In various embodiments, the messaging module 160 may be configured to display the request to the customer 155.

In various embodiments, the customer device 150 may be additionally configured to include a confirmation module 170. In various embodiments, the confirmation module 170 may be configured to accept an indication from the customer 155 that the customer 155 wishes to participate in a transaction. In various embodiments, the confirmation module 170 may be configured to receive such an indication upon selection of a link or other user interface (“UI”) element by the customer 155; such a link or UI element may be caused to be displayed by the message received by the messaging module 160.

Thus, in some embodiments, after receipt of a message requesting confirmation that the customer wishes to participate in a transaction, the messaging module 160 may display the request to the customer 155. If the customer 155 then wishes to confirm his or her wish to participation in the transaction, such as by activation of a link or other UI element, the messaging module may cause the confirmation module 170 to be activated.

The confirmation module 170 may further be configured such that, upon receipt of the indication from the customer 155 that the customer 155 wishes to participate in the transaction, the confirmation module 170 may send a confirmation message to the TFS 100. In various embodiments, the confirmation message may be sent by SMS; however in other embodiments, other protocols, such as TCP/IP or other internet protocols, may be utilized.

In various embodiments, the confirmation module 170 may be configured to include a unique identifier 180 that is associated with the customer device 150 in the confirmation message sent to the TFS 100. In various embodiments, the unique identifier 180 may include an IMEI number for the customer device 150. In other embodiments, other unique identifiers, such as a phone number for the customer device 150, may be utilized. While the example of FIG. 1, as well as other examples herein, use IMEI number as the unique identifier 180, it may be recognized that other unique identifiers 180, such as phone numbers, may be utilized in various embodiments. In various embodiments, the confirmation module 170 may be configured to encrypt the unique identifier 180 before sending the confirmation message.

In various embodiments, through receipt of the request message (based on an entered phone number) and sending of the confirmation message that includes the IMEI number, the modules of the customer device 150 may provide reassurance that the person in control of the customer device 150 is the same customer 155 that is requesting to participate in the transaction with the provider 190. This may provide an increased level of security to the customer 155 and/or the provider 190 without requiring sharing of additional identifying information.

In various embodiments, the TFS 100 may be configured with additional modules configured to perform various operations upon receipt of the confirmation message from the customer device 150. For example, in various embodiments, the TFS 100 may include an identity verification module 140. The identity verification module 140 may be configured to confirm an identity of the customer 155 based, at least in part, on receipt of the confirmation message from the customer device 150. In various embodiments, the identity verification module 140 may be configured to decrypt an encrypted unique identifier 180 found in the confirmation message.

In various embodiments, the identify verification module 140 may be additionally configured to perform additional identity verification activities. For example, in various embodiments, the request received from the provider 190 may include additional identifying information for the customer 155. In various embodiments, the identifying information may include information such as name information, financial information, location, etc. In various embodiments, the identity verification module 140 may additionally refer to identifying information that has been previously stored at the TFS 100, such as in the customer information storage 145. Thus, in various embodiments, the TFS 100 may act to compare the identifying information received in the request with information stored in the customer information storage 145. This identifying information may be retrieved with reference to one or more received identifiers, such as the phone number received in the request from the provider 190 and/or the IMEI received in the confirmation message received from the customer device 150. In various embodiments, the information stored in the customer information storage 145 may have been previously provided by the customer 155 to the TFS 100.

In various embodiments, the TFS 100 may also include a payment servicing module 130. The payment servicing module 130 may be configured to interact with a payment entity (not illustrated), such as a bank, credit union, credit card provider, or other entity, to facilitate payments between the customer 155 and the provider 190. In various embodiments, the payment servicing module 130 may be configured to work with the payment entity to take payment itself from one of the customer 155 or the provider 190. The TFS 100 may then provide the taken payment, in whole or in part, to the other of the customer 155 or the provider 190. By operating as an intermediary between the customer 155 and the provider 190, the TFS 100 may provide additional security such that financial information may not be required to be transferred between the customer 155 and the provider 190. In various embodiments, the TFS 100 may, after performing these activities, provide a confirmation of the customer's wish to participate in the transaction back to the provider 190, such as through the provider interface 110. The provider may then, in turn, complete the transaction with the customer 155. Particular examples of transaction completion are described below.

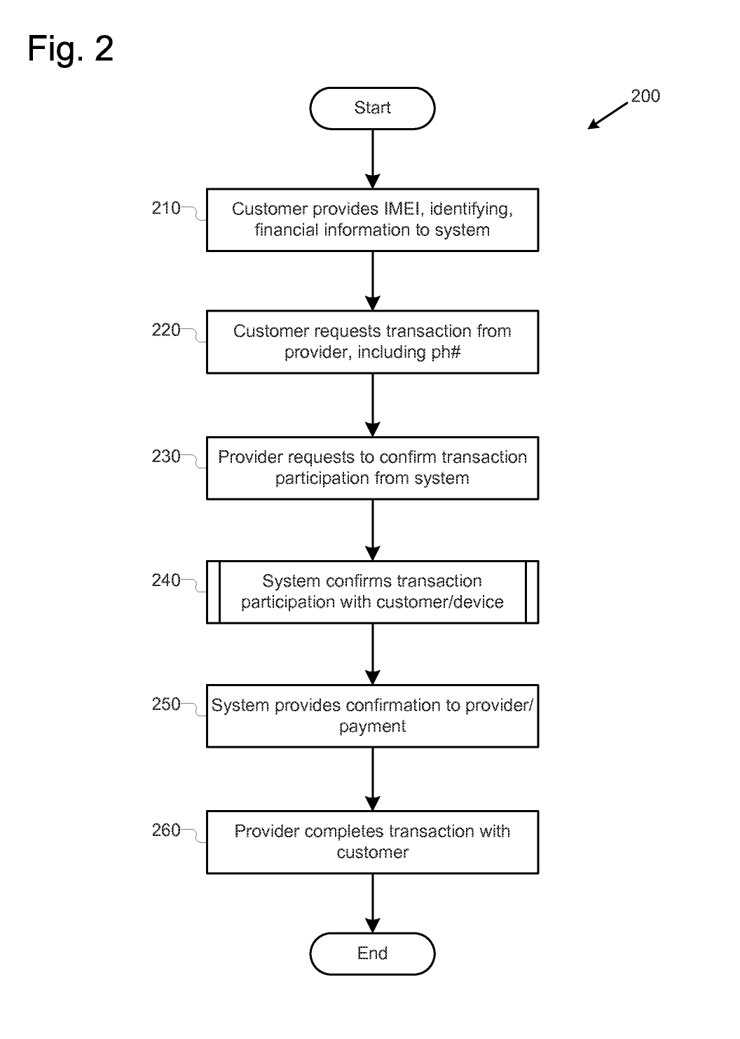

Referring now to FIG. 2, an example process for facilitating transactions is illustrated in accordance with various embodiments. While FIG. 2 illustrates particular operations in a particular order, in various embodiments, the operations may be combined, split into parts, and/or omitted. The process may begin at operation 210, where the customer 155 may provide identifying information to the TFS 100. As discussed above, in various embodiments, the identifying information may include information about the customer device 150, such as phone number and/or IMEI (or other unique ID) or information about the customer 155, such as financial information, name information, address information, location information, or other information. In various embodiments, at operation 210, the TFS 100 may store the information received from the customer 155 for subsequent identification activities, such as by storing the information in the customer information storage 145.

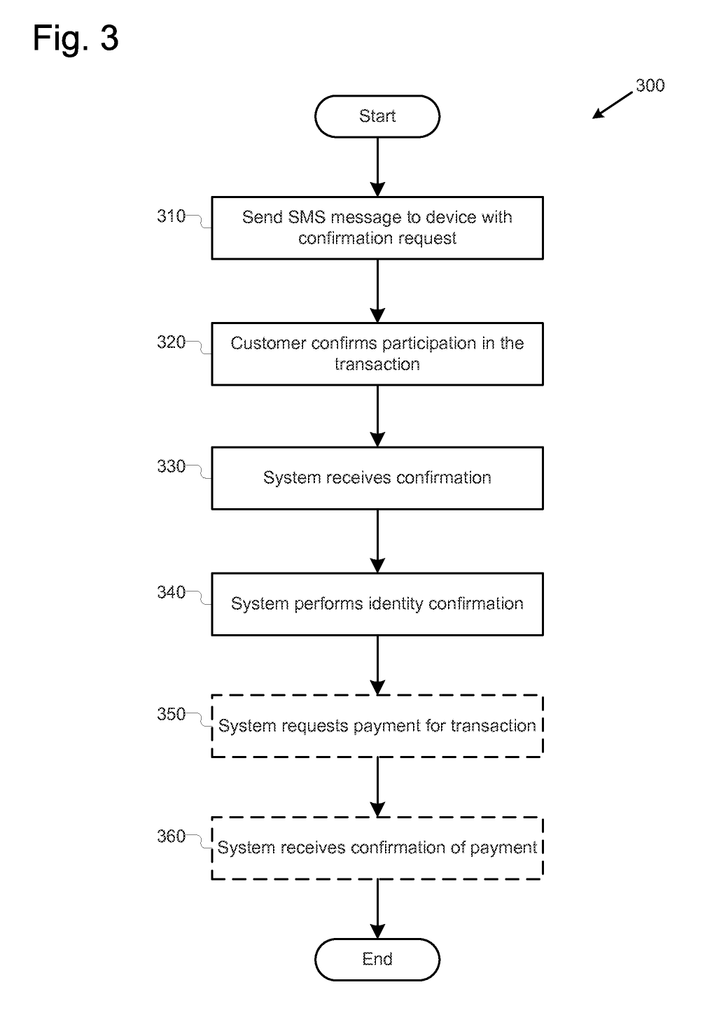

Next, at operation 220, the customer 155 may request a transaction from the provider 190. In various embodiments, during operation 220, the customer 155 may provide their phone number and/or other identifying information to the provider 190. Next, at operation 230, the provider 190 may send a request to the TFS 100 to confirm the customer 155's wish to participate in the transaction. In various embodiments, at operation 230 the provider 190 may send identifying information, such as the previously-received phone number and/or other identifying information, as part of the request. Next, at operation 240, the TFS 100 may confirm that the customer 155 wishes to participate in the transaction. Particular examples of operation 240 are described below with reference to process 300 of FIG. 3.

At operation 250, the TFS may provide a confirmation to the provider 190 that the customer 155 wishes to participate in the transaction. In some embodiments, the TFS 100 may also provide payment to the customer 155 or the provider 190, such as when the transaction is a purchase transaction. Then, at operation 260, the provider 190 may complete the transaction with the customer. Particular examples of transaction completion are described below. The process may then end.

Referring now to FIG. 3, an example process 300 for confirming a customer's wish to participate in a transaction is illustrated in accordance with various embodiments. While FIG. 3 illustrates particular operations in a particular order, in various embodiments, the operations may be combined, split into parts, and/or omitted. In various embodiments, the operations described in process 300 may be performed as one or more implementations of operation 240 of process 200.

The process may begin at operation 310, where the TFS 100 may send a message, such as an SMS message, to the customer device 150 with a request to confirm the customer 155's wish to participate in the transaction. In other embodiments, other protocols other than SMS may be utilized. Next, at operation 320, the customer may confirm participation in the transaction. In various embodiments, the customer may confirm participation by selecting a link or other UI element on the customer device 150 from the received message. Next, at operation 330, the TFS 100 may receive a confirmation message from the customer device 150. In various embodiments, the confirmation module 170 may send the confirmation message to the TFS 100. In various embodiments, the confirmation message may include the IMEI or other unique identifier for the customer device 150.

Next, at operation 340, the TFS 100 may perform an identity confirmation for the customer 155. In various embodiments, the TFS 100 may be configured to compare the IMEI (or other unique identifier) and identifying information to previously-stored identifying information. Such information may be stored in the customer information storage 145, as described above. The TFS 100 may be configured, in various embodiments, to confirm identity if there is a match of a predetermined number or amount of identifying information. For example, in some embodiments, the TFS 100 may be configured to match the received IMEI (or other unique identifier) with a stored IMEI. In other embodiments, other identifying information may be compared, and a match may be determined if sufficient information substantially matches.

Next, at operation 350, the TFS 100 may operationally request payment for the transaction, such as from a payment entity, such as through operation of the payment servicing module 130. The TFS 100 may request payment from a payment entity such as a bank, credit union, credit card provider, or other entity. Next, at operation 360, the TFS 100 may receive confirmation of the payment, such as from the payment entity. In various embodiments, as discussed above, the payment may be requested from one of the customer 155 or the provider 190 and to the other of the customer 155 or the provider 190. In various embodiments, operation 350 (as well as operation 360) may not be performed if the transaction does not involve the transfer of money. In various embodiments, the payment may be made directly to an entity associated with the TFS 100 such that funds may be paid between the customer 155 and the provider 190 without exchanging financial information between then. After the optional performance of operation 360, the process may then end.

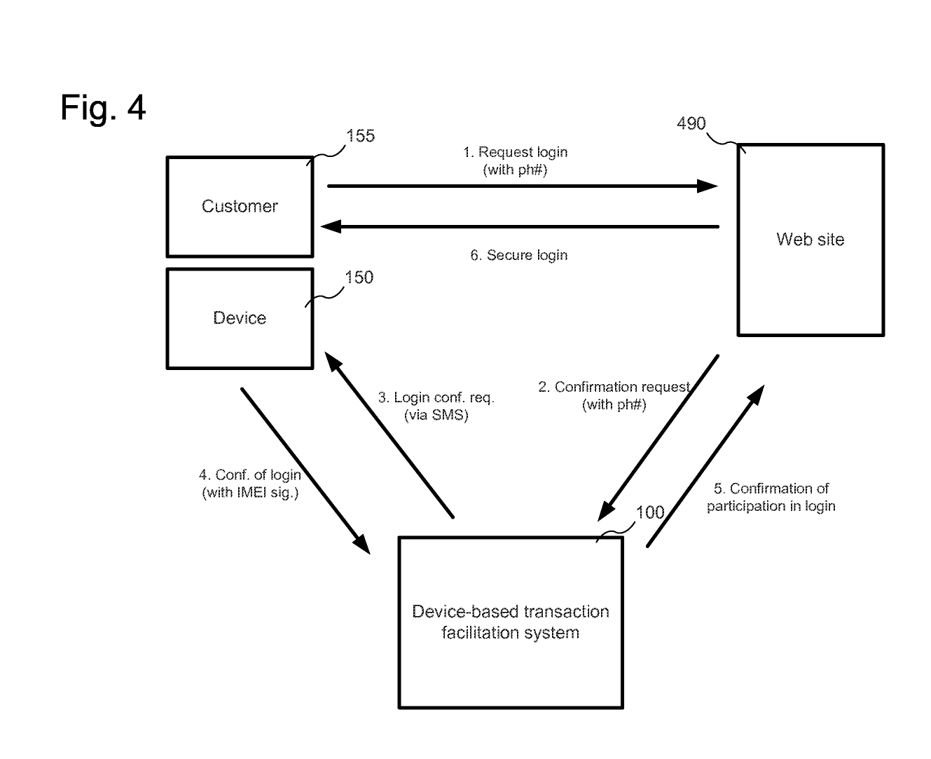

Referring now to FIG. 4, an example use case of facilitating a login transaction is illustrated in accordance with various embodiments. In the example, the customer 155 is attempting to login to a web site 490. The example may begin at action 1, where the customer 155 may request a login from the web site 490 along with the customer 155's phone number. Next, at action 2, the web site 490 may send a request to the TFS 100 to confirm that the identified customer 155 does indeed intend to log in. At action 3, the TFS 100 may send a login confirmation request to the customer device 150. The customer device then, at action 4, may send confirmation of the customer 155's intention to log in to the website. This confirmation may include the IMEI for the customer device 150. Then at action 5, the TFS (after confirming the identity of the customer 155) may send a confirmation of the customer 155's intention to participate in the login. Then, at action 6, the web site, having gotten confirmation that the identified customer intends to log in, may provide a secure login to the customer 155.

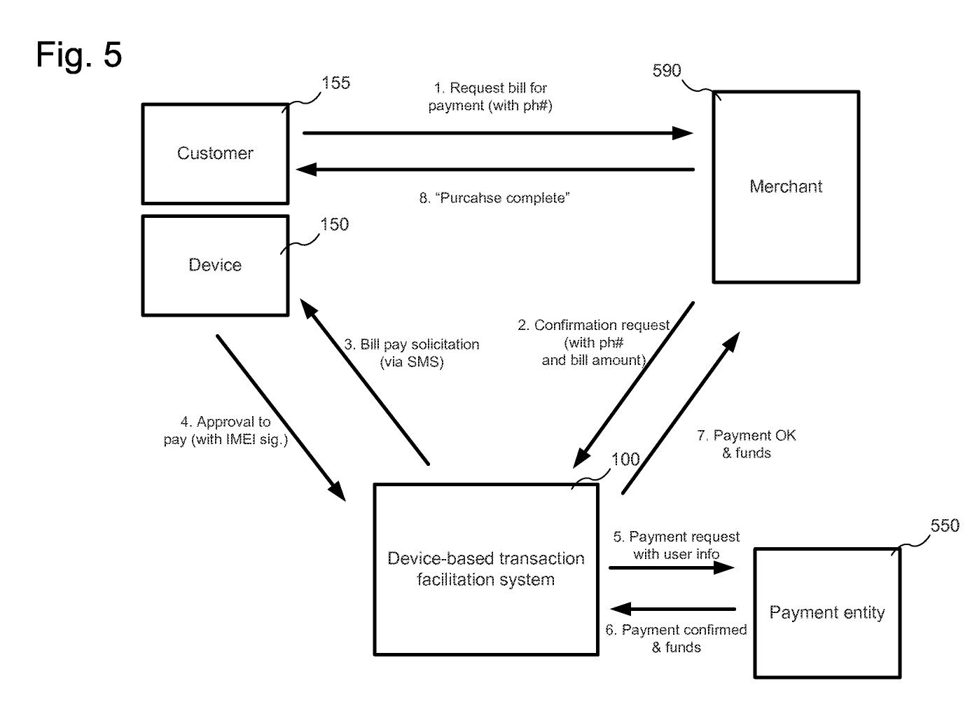

Referring now to FIG. 5, an example use case of facilitating a purchase transaction is illustrated in accordance with various embodiments. In the example, the customer 155 is attempting to make a purchase from a merchant 590. The example may begin at action 1, where the customer 155 may request a bill for payment from the merchant 590, and provide the customer 155's phone number along with the request. Next, at action 2, the merchant 590 may send a request, along with the bill amount and the phone number, to the TFS 100 to confirm that the identified customer 155 does indeed intend to make the purchase. At action 3, the TFS 100 may send a bill payment confirmation request to the customer device 150. The customer device then, at action 4, may send confirmation of the customer 155's intention to pay the identified bill. This confirmation may include the IMEI for the customer device 150. Next, at action 5, the TFS 100 (after confirming the identity of the customer 155) may make a payment request for the purchase amount from a payment entity 550. At action 6, the payment entity may confirm the payment and provide funds to the TFS 100 (or another entity associated with the TFS 100). Then at action 7, the TFS may send a confirmation of the customer 155's intention to make the purchase and may pay the funds to the merchant 590. Then, at action 8, the web site, having gotten confirmation that the identified customer intends to log in, may indicate to the customer 155 that the purchase is complete and may provide the purchased item and/or service to the customer 155.

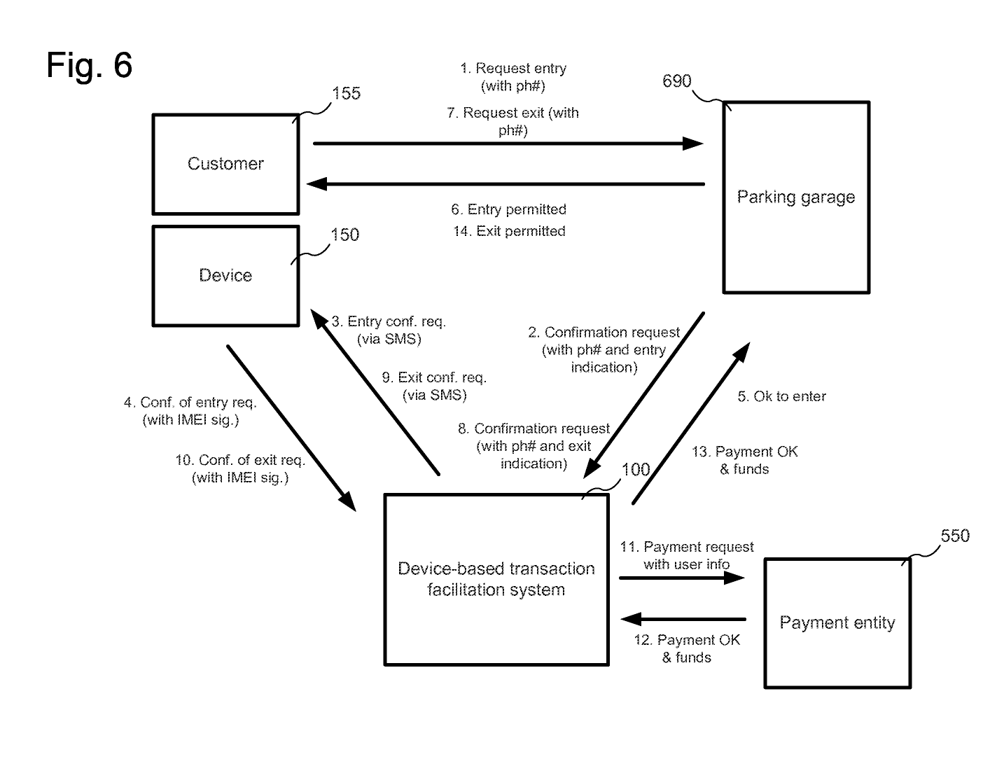

Referring now to FIG. 6, an example use case of facilitating a time-based transaction is illustrated in accordance with various embodiments. In the example, the customer 155 is attempting to park in a parking garage that charges per amount of time. The example may begin at action 1, where the customer 155 may request entry from the garage 690, and provide the customer 155's phone number along with the request. Next, at action 2, the parking garage 690 may send an entry request, along with the phone number, to the TFS 100 to confirm that the identified customer 155 does indeed intend to enter the parking garage 690. At action 3, the TFS 100 may send an entry confirmation request to the customer device 150. The customer device then, at action 4, may send confirmation of the customer 155's intention to enter. This confirmation may include the IMEI for the customer device 150. Next, at action 5, the TFS 100 (after confirming the identity of the customer 155) may send an “OK to enter” confirmation to the parking garage 690, after which, at action 6, the parking garage 690 may permit the customer 155 to enter. The TFS may also record a time of the entrance for later payment purposes.

Later, at action 7, when the customer wishes to exit, the customer 155 may request exit from the garage 690, and provide the customer 155's phone number along with the request. Next, at action 8, the parking garage 690 may send an exit request, along with the phone number, to the TFS 100 to confirm that the identified customer 155 does indeed intend to exit the parking garage 690. At action 9, the TFS 100 may send an exit confirmation request to the customer device 150. The customer device then, at action 10, may send confirmation of the customer 155's intention to exit. This confirmation may include the IMEI for the customer device 150. Next, at action 11, the TFS 100 may record the exit time and may make a payment request to a payment entity 550. The payment request may include a payment amount based at least in part on the difference between the entry time and the exit time. Then, at action 12, the payment entity may confirm the payment and provide funds to the TFS 100 (or another entity associated with the TFS 100). Next, at action 13 the TFS 100 (after confirming the identity of the customer 155) may send an “OK to exit” confirmation to the parking garage 690, along with the payment funds. After this, at action 14, the parking garage 690 may permit the customer 155 to exit.

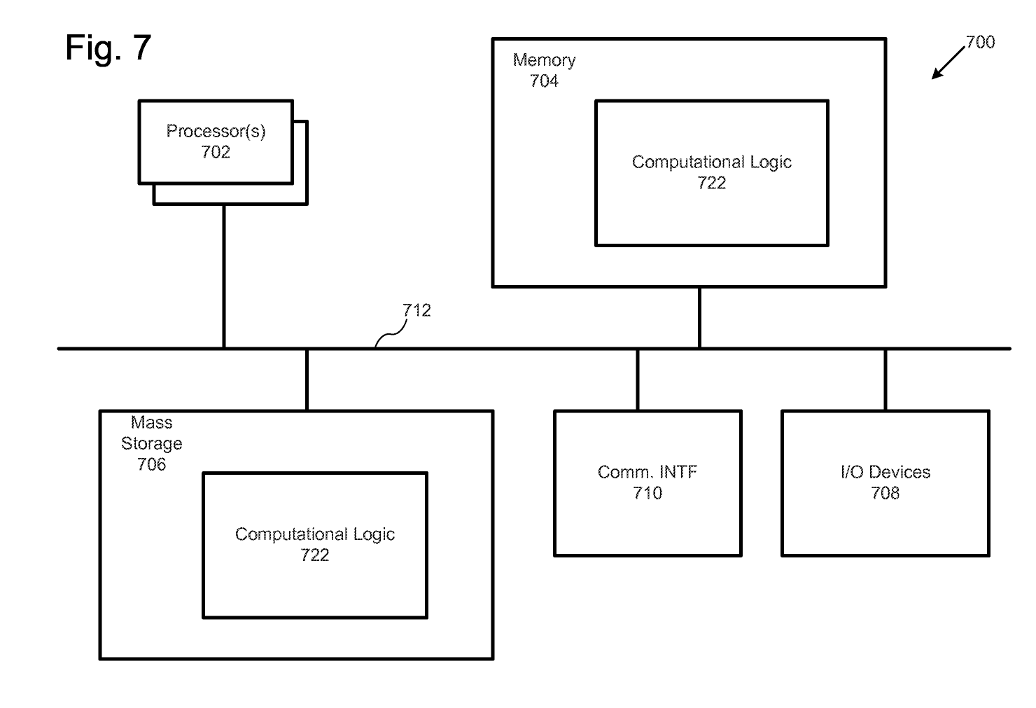

Referring now to FIG. 7, an example computer suitable for practicing various aspects of the present disclosure, including processes of FIGS. 2-6, is illustrated in accordance with various embodiments. As shown, computer 700 may include one or more processors or processor cores 702, and system memory 704. For the purpose of this application, including the claims, the terms “processor” and “processor cores” may be considered synonymous, unless the context clearly requires otherwise. Additionally, computer 700 may include mass storage devices 706 (such as diskette, hard drive, compact disc read only memory (CD-ROM) and so forth), input/output devices 708 (such as display, keyboard, cursor control, remote control, gaming controller, image capture device, and so forth) and communication interfaces 710 (such as network interface cards, modems, infrared receivers, radio receivers (e.g., Bluetooth), and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the modules shown in FIG. 1, and/or the operations associated with techniques shown in FIGS. 2-6, collectively referred to as computing logic 722. The various elements may be implemented by assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of the agent program may be employed to distribute the agent and program various computing devices. In embodiments, the programming instructions may be stored in one or more computer readable non-transitory storage media. In other embodiments, the programming instructions may be encoded in transitory storage media, such as signals.

The number, capability and/or capacity of these elements 710-712 may vary. Their constitutions are otherwise known, and accordingly will not be further described.

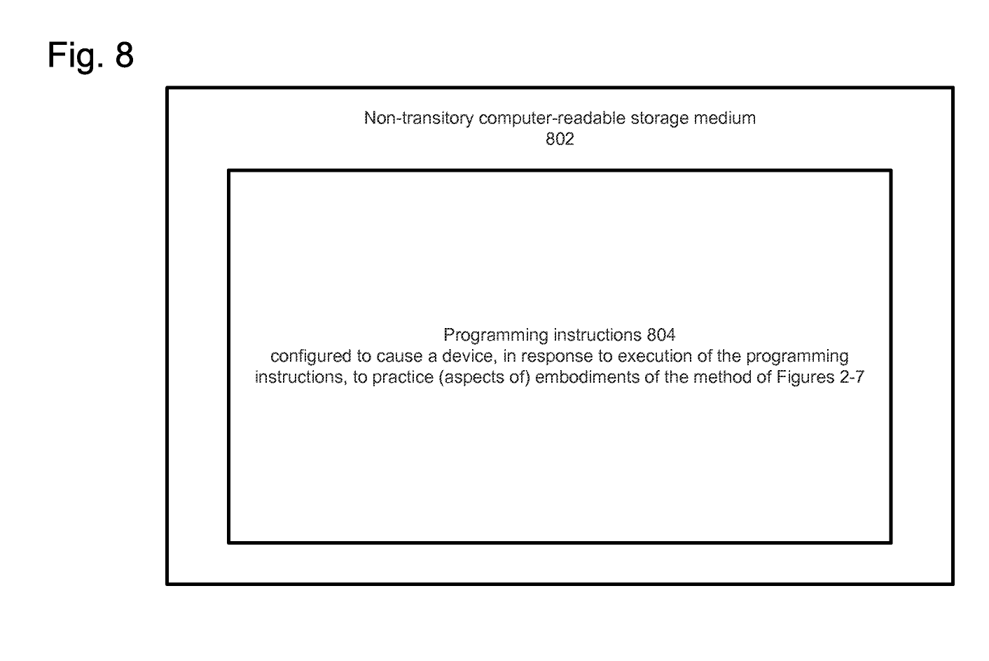

FIG. 8 illustrates an example least one computer-readable storage medium 802 having instructions configured to practice all or selected ones of the operations associated with the techniques earlier described, in accordance with various embodiments. As illustrated, least one computer-readable storage medium 802 may include a number of programming instructions 804. Programming instructions 804 may be configured to enable a device, e.g., computer 700, in response to execution of the programming instructions, to perform, e.g., various operations of processes of FIGS. 2-6, e.g., but not limited to, to the various operations performed to perform facilitation of transactions. In alternate embodiments, programming instructions 804 may be disposed on multiple least one computer-readable storage media 802 instead.

Various embodiments of the present disclosure have been described. These embodiments include, but are not limited to, those described in the following paragraphs.

Example 1 includes one or more computer-readable media including instructions that are configured to cause a computing device, in response to execution by the computing system, to facilitate confirmation of transactions. The instructions cause the computing device to: send a message to a device of a first party, the message requesting confirmation that the first party wishes to participate in a transaction with a second party; receive a confirmation of the first party's wish to participate in the transaction from the first party, the confirmation including a unique identifier of the device of the first party; and in response to the receipt of the confirmation including the unique identifier of the device, indicate to the second party that the first party has confirmed participation in the transaction.

Example 2 includes the computer-readable media of example 1, wherein the unique identifier includes an International Mobile Station Equipment Identity number for the device of the first party.

Example 3 includes the computer-readable media of example 2, wherein the unique identifier includes an encrypted version of the International Mobile Station Equipment Identity number for the device of the first party.

Example 4 includes the computer-readable media of example 1, wherein the unique identifier includes a phone number for the device of the first party.

Example 5 includes the computer-readable media of example 1, wherein the instructions are further configured to cause the computing device to confirm an identity of the first party based at least in part on the unique identifier.

Example 6 includes the computer-readable media of example 1, wherein the instructions are further configured to cause the computing device to, prior to the message being sent, receive, from the second party, a request to confirm the first party's wish to participate in the transaction, the request identifying the first party or a communication address assigned to the device of the first party.

Example 7 includes the computer-readable media of example 6, wherein the device of the first party is a phone.

Example 8 includes the computer-readable media of example 7, wherein the request to confirm the first party's wish to participate in the transaction includes a phone number for the phone.

Example 9 includes the computer-readable media of example 8, wherein the message sent to the device is a Short Message Service message.

Example 10 includes the computer-readable media of example 1, wherein the instructions are further configured to cause the computing device to: receive, prior to indication to the second party, the unique identifier of the device of the first party and identification information for the first party, and store the unique identifier and the identification information such that the unique identifier and the identification information can be retrieved for subsequent confirmation of transactions.

Example 11 includes the computer-readable media of example 1, wherein the instructions are further configured to cause the computing device to facilitate a payment by the first party to the second party.

Example 12 includes the computer-readable media of example 11, wherein facilitate the payment includes: facilitate a payment from the first party to a third party; and facilitate a payment from the third party to the second party.

Example 13 includes the computer-readable media of example 12, wherein the third party is associated with the one or more computing devices.

Example 14 includes the computer-readable media of example 1, wherein the transaction is a request for the first party to be logged in to a secure service provided by the second party.

Example 15 includes the computer-readable media of example 1, wherein the transaction is a purchase transaction between the first party and the second party.

Example 16 includes the computer-readable media of example 1, wherein the transaction is a time based transaction between the first party and the second party.

Example 17 includes the computer readable media of example 1, wherein the transaction is a time-based transaction. The instructions are also further configured to cause the computing device to: record a first time the first party has confirmed the first party's wish to participate in the transaction; repeat the sending, receiving, confirming, and indicating contemporaneously at a second time; record the second time; and facilitate payment from the first party to the second party based on a time difference between the first time and the second time.

Example 18 includes an apparatus for facilitation of confirmation of transactions. The apparatus includes: one or more computing processors; and logic configured to operate on the one or more computing processors. The logic operates on the one or more processors to: send a message to a device of a first party, the message requesting confirmation that the first party wishes to participate in a transaction with a second party; receive a confirmation of the first party's wish to participate in the transaction from the first party, the confirmation including a unique identifier of the device of the first party; and in response to the receipt of the confirmation including the unique identifier of the device, indicate to the second party that the first party has confirmed participation in the transaction.

Example 19 includes the apparatus of example 18, wherein the unique identifier includes an International Mobile Station Equipment Identity number for the device.

Example 20 includes the apparatus of example 19, wherein the unique identifier includes an encrypted version of the International Mobile Station Equipment Identity number for the device.

Example 21 includes the apparatus of example 18, wherein the unique identifier includes a phone number for the device.

Example 22 includes the apparatus of example 18, wherein the logic is further configured to operate to confirm an identity of the first party based at least in part on the unique identifier.

Example 23 includes the apparatus of example 18, wherein the logic is further configured to operate to, prior to the message being sent, receive, from the second party, a request to confirm the first party's wish to participate in the transaction, the request identifying the first party or a communication address assigned to the device of the first party.

Example 24 includes the apparatus of example 23, wherein: the device of the first party is a phone, and the request to confirm the first party's wish to participate in the transaction includes a phone number for the phone.

Example 25 includes the apparatus of example 24, wherein the message sent to the device is a Short Message Service message.

Example 26 includes the apparatus of example 18, wherein the logic is further configured to operate to facilitate a payment by the first party to the second party.

Example 27 includes the apparatus of example 18, wherein the transaction includes one or more of: a request for the first party to be logged in to a secure service provided by the second party; a purchase transaction between the first party and the second party; or a time based transaction between the first party and the second party.

Example 28 includes a computer-implemented method for facilitation of confirmation of transactions. The method includes: sending, by a computing system, a message to a device of a first party, the message requesting confirmation that the first party wishes to participate in a transaction with a second party; receiving, by the computing system, a confirmation of the first party's wish to participate in the transaction from the first party, the confirmation including a unique identifier of the device of the first party; and in response to the receipt of the confirmation including the unique identifier of the device, indicating, by the computing system, to the second party that the first party has confirmed participation in the transaction.

Example 29 includes the method of example 28, wherein the unique identifier includes an International Mobile Station Equipment Identity number for the device.

Example 30 includes the method of example 28, wherein the unique identifier includes a phone number for the device.

Example 31 includes the method of example 28, further including confirming, by the computing system, an identity of the first party based at least in part on the unique identifier.

Example 32 includes the method of example 28, further including receiving, from the second party, by the computing system prior to the message being sent, a request to confirm the first party's wish to participate in the transaction, the request identifying the first party or a communication address assigned to the device of the first party.

Example 33 includes the method of example 32, wherein the device of the first party is a phone, and the request to confirm the first party's wish to participate in the transaction includes a phone number for the phone.

Example 34 includes the method of example 33, wherein the message sent to the device is a Short Message Service message.

Example 35 includes the method of example 28, further including facilitating, by the computing system, a payment by the first party to the second party.

Example 36 includes the method of example 28, wherein the transaction includes one or more of: a request for the first party to be logged in to a secure service provided by the second party; a purchase transaction between the first party and the second party; or a time based transaction between the first party and the second party.

Example 37 includes one or more computer-readable media including instructions that are configured to cause a mobile device, in response to execution of the instructions by the mobile device, to facilitate confirmation of transactions. The instructions cause the mobile device to: receive a request to confirm intent to participate in a transaction with a second party; display the request on the mobile device of a first party; receive confirmation of the first party's intent to participate in the transaction; and send a confirmation of the first party's intent to participate in the transaction, the confirmation including a unique identifier of the mobile device.

Example 38 includes the computer-readable media of example 37, wherein the unique identifier includes an International Mobile Station Equipment Identity number for the mobile device.

Example 39 includes the computer-readable media of example 38, wherein send the confirmation includes encrypt the International Mobile Station Equipment Identity number for the mobile device before send of the confirmation.

Example 40 includes the computer-readable media of example 37, wherein receive the request to confirm intent to participate includes receive a Short Message Service (SMS) message.

Example 41 includes a mobile device for facilitation of confirmation of transactions. The mobile device includes: one or more computing processors and logic configured to operate on the one or more computing processors. The logic is configured to operate on the one or more computing processors to: receive a request to confirm intent to participate in a transaction with a second party; display the request on the mobile device of a first party; receive confirmation of the first party's intent to participate in the transaction; and send a confirmation of the first party's intent to participate in the transaction, the confirmation including a unique identifier of the mobile device.

Example 42 includes the mobile device of example 41, wherein the unique identifier includes an International Mobile Station Equipment Identity number for the mobile device.

Example 43 includes the mobile device of example 42, wherein send the confirmation includes encrypt the International Mobile Station Equipment Identity number for the mobile device before send of the confirmation.

Example 44 includes the mobile device of example 41, wherein receive the request to confirm intent to participate includes receive a Short Message Service (SMS) message.

Example 45 includes a computer-implemented method for facilitation of confirmation of transactions. The method includes: receiving, by a mobile computing device, a request to confirm intent to participate in a transaction with a second party; displaying, by the mobile computing device, the request on the mobile device of a first party; receiving, by the mobile computing device, confirmation of the first party's intent to participate in the transaction; and sending, by the mobile computing device, a confirmation of the first party's intent to participate in the transaction, the confirmation including a unique identifier of the mobile device.

Example 46 includes the method of example 45, wherein the unique identifier includes an International Mobile Station Equipment Identity number for the mobile device.

Example 47 includes the method of example 46, wherein sending the confirmation includes encrypting the International Mobile Station Equipment Identity number for the mobile device before send of the confirmation.

Example 48 includes the method of example 45, wherein receiving the request to confirm intent to participate includes receiving a Short Message Service (SMS) message.

Example 49 includes one or more computer-readable media including instructions that are configured to cause a first computing system, in response to execution of the instruction by the first computing system, to facilitate confirmation of transactions. The instructions cause the computing device to: receive a request for a transaction from an individual party, the request including a communication address of a communication device of the individual party; send a transaction confirmation request to a second computing system, the request including the communication address of the communication device, and requesting confirmation that the individual party wishes to participate in the transaction; receive an indication from the second computing system that the individual party has confirmed through the second computing system that the individual party wishes to participate in the transaction, the confirmation being provided by the second computing system in response to receipt of a communication to the second computing system from a communication device of the individual party confirming that the individual party wishes to participate in the transaction, the communication having a unique identifier of the communication device of the individual party; and complete the transaction with the individual party.

Example 50 includes the computer-readable media of example 49, wherein complete the transaction includes complete a purchase transaction with the individual party.

Example 51 includes the computer-readable media of example 50, wherein send the transaction confirmation request includes send an indication of an amount of money to complete the transaction.

Example 52 includes the computer-readable media of example 51, wherein the instructions are further configured to cause the first computing system to receive one or more payments from the individual party, the payments facilitated by the computing system.

Example 53 includes the computer-readable media of example 49, wherein complete the transaction includes allow the individual party access to a secure web-based service.

Example 54 includes an apparatus for facilitation of confirmation of transactions. The apparatus includes one or more computing processors and logic configured to operate on the computing processors. The logic is configured to operate on the one or more computing processors to: receive a request for a transaction from an individual party, the request including a communication address of a communication device of the individual party; send a transaction confirmation request to a computing system, the request including the communication address of the communication device, and requesting confirmation that the individual party wishes to participate in the transaction; receive an indication from the computing system that the individual party has confirmed through the computing system that the individual party wishes to participate in the transaction, the confirmation being provided by the computing system in response to receipt of a communication to the computing system from a communication device of the individual party confirming that the individual party wishes to participate in the transaction, the communication having a unique identifier of the communication device of the individual party; and complete the transaction with the individual party.

Example 55 includes the apparatus of example 54, wherein complete the transaction includes complete a purchase transaction with the individual party.

Example 56 includes the apparatus of example 55, wherein send the transaction confirmation request includes send an indication of an amount of money to complete the transaction.

Example 57 includes the apparatus of example 56, wherein the logic is further configured to operate to receive one or more payments from the individual party, the payments facilitated by the computing system.

Example 58 includes the apparatus of example 54, wherein complete the transaction includes allow the individual party access to a secure web-based service.

Example 59 includes a computer-implemented method for facilitation of confirmation of transactions. The method includes: receiving, by a first computing system, a request for a transaction from an individual party, the request including a communication address of a communication device of the individual party; sending, by the first computing system, a transaction confirmation request to a second computing system, the request including the communication address of the communication device, and requesting confirmation that the individual party wishes to participate in the transaction; receiving, by the first computing system, an indication from the second computing system that the individual party has confirmed through the second computing system that the individual party wishes to participate in the transaction, the confirmation being provided by the second computing system in response to receipt of a communication to the second computing system from a communication device of the individual party confirming that the individual party wishes to participate in the transaction, the communication having a unique identifier of the communication device of the individual party; and completing, by the first computing system, the transaction with the individual party.

Example 60 includes the method of example 59, wherein completing the transaction includes completing a purchase transaction with the individual party.

Example 61 includes the method of example 60, wherein sending the transaction confirmation request includes sending an indication of an amount of money to complete the transaction.

Example 62 includes the method of example 61, further including receiving, by the first computing system, one or more payments from the individual party, the payments facilitated by the computing system.

Example 63 includes the method of example 59, wherein completing the transaction includes allowing the individual party access to a secure web-based service.

Computer-readable media (including at least one computer-readable media), methods, apparatuses, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable media comprising instructions to cause a computing system, in response to execution by the computing system, to facilitate confirmation of transactions, wherein the computing system is caused to:
send a message to a device of a first party, wherein the message requests confirmation that the first party wishes to participate in a transaction with a second party;
receive a confirmation of the first party's wish to participate in the transaction from the first party, wherein the confirmation includes a unique identifier of the device of the first party; and
in response to the receipt of the confirmation that includes the unique identifier of the device of the first party, indicate to the second party that the first party has confirmed participation in the transaction.

2. The computer-readable media of claim 1, wherein the unique identifier comprises an International Mobile Station Equipment Identity number for the device of the first party.

3. The computer-readable media of claim 2, wherein the unique identifier comprises an encrypted version of the International Mobile Station Equipment Identity number for the device of the first party.

4. The computer-readable media of claim 1, wherein the unique identifier comprises a phone number for the device of the first party.

5. The computer-readable media of claim 1, wherein the computing system is further caused to confirm an identity of the first party based at least in part on the unique identifier.

6. The computer-readable media of claim 1, wherein the computing system is further caused to, prior to the message being sent, receive, from the second party, a request to confirm the first party's wish to participate in the transaction, wherein the request identifies the first party or a communication address assigned to the device of the first party.

7. The computer-readable media of claim 6, wherein the device of the first party is a phone.

8. The computer-readable media of claim 7, wherein the request to confirm the first party's wish to participate in the transaction includes a phone number for the phone.

9. The computer-readable media of claim 8, wherein the message sent to the device of the first party is a Short Message Service message.

10. The computer-readable media of claim 1, wherein the computing system is further caused to:
receive, prior to indication to the second party, the unique identifier of the device of the first party and identification information for the first party; and
store the unique identifier and the identification information such that the unique identifier and the identification information can be retrieved for subsequent confirmation of transactions.

11. The computer-readable media of claim 1, wherein the computing system is further caused to facilitate a payment by the first party to the second party.

12. The computer-readable media of claim 11, wherein facilitate the payment comprises:
facilitate a payment from the first party to a third party; and
facilitate a payment from the third party to the second party.

13. The computer-readable media of claim 12, wherein the third party is associated with the computing system.

14. The computer-readable media of claim 1, wherein the transaction is a request for the first party to be logged in to a secure service provided by the second party.

15. The computer-readable media of claim 1, wherein the transaction is a purchase transaction between the first party and the second party.

16. The computer-readable media of claim 1, wherein the transaction is a time based transaction between the first party and the second party.

17. The computer readable media of claim 1, wherein:
the transaction is a time-based transaction;
the computing system is further caused to:
record a first time the first party has confirmed the first party's wish to participate in the transaction;
repeat the sending, receiving, confirming, and indicating contemporaneously at a second time;
record the second time; and
facilitate payment from the first party to the second party based on a time difference between the first time and the second time.

18. An apparatus for facilitation of confirmation of transactions, the apparatus comprising:
one or more computing processors;
logic to operate on the one or more computing processors to:
send a message to a device of a first party, wherein the message requests confirmation that the first party wishes to participate in a transaction with a second party;
receive a confirmation of the first party's wish to participate in the transaction from the first party, wherein the confirmation includes a unique identifier of the device of the first party; and
in response to the receipt of the confirmation that includes the unique identifier of the device of the first party, indicate to the second party that the first party has confirmed participation in the transaction.

19. The apparatus of claim 18, wherein the unique identifier comprises an International Mobile Station Equipment Identity number for the device of the first party.

20. The apparatus of claim 18, wherein the unique identifier comprises a phone number for the device.

21. The apparatus of claim 18, wherein the logic is further to operate to confirm an identity of the first party based at least in part on the unique identifier.

22. The apparatus of claim 18, wherein the logic is further to operate to, prior to the message being sent, receive, from the second party, a request to confirm the first party's wish to participate in the transaction, wherein the request identifies the first party or a communication address assigned to the device of the first party.

23. The apparatus of claim 22, wherein:
the device of the first party is a phone; and
the request to confirm the first party's wish to participate in the transaction includes a phone number for the phone.

24. The apparatus of claim 18, wherein the logic is further configured to operate to facilitate a payment by the first party to the second party.

25. The apparatus of claim 18, wherein the transaction comprises one or more of:
a request for the first party to be logged in to a secure service provided by the second party;
a purchase transaction between the first party and the second party; or
a time based transaction between the first party and the second party.

26. A computer-implemented method for facilitating confirmation of transactions, the method comprising:
sending, by a computing system, a message to a device of a first party, the message requesting confirmation that the first party wishes to participate in a transaction with a second party;
receiving, by the computing system, a confirmation of the first party's wish to participate in the transaction from the first party, the confirmation including a unique identifier of the device of the first party; and
in response to the receipt of the confirmation including the unique identifier of the device of the first party, indicating, by the computing system, to the second party that the first party has confirmed participation in the transaction.

27. The method of claim 22, wherein the unique identifier comprises an International Mobile Station Equipment Identity number for the device of the first party.

28. The method of claim 22, further comprising confirming, by the computing system, an identity of the first party based at least in part on the unique identifier.

29. The method of claim 22, further comprising receiving, from the second party, by the computing system prior to the message being sent, a request to confirm the first party's wish to participate in the transaction, the request identifying the first party or a communication address assigned to the device of the first party.

30. The method of claim 22, further comprising facilitating, by the computing system, a payment by the first party to the second party.

31. The method of claim 22, wherein the transaction comprises one or more of:
a request for the first party to be logged in to a secure service provided by the second party;
a purchase transaction between the first party and the second party; or
a time based transaction between the first party and the second party.
